(19) United States
(12) Patent Application Publication
(10) Pub. No.: US 2023/0401082 A1
(43) Pub. Date: Dec. 14, 2023

(54) MULTI-GPU DEVICE PCIE TOPOLOGY RETRIEVAL IN GUEST VM

(71) Applicant: ATI Technologies ULC, Markham (CA)

(72) Inventors: Yinan Jiang, Markham (CA); Shaoyun Liu, Markham (CA)

(21) Appl. No.: 17/839,821

(22) Filed: Jun. 14, 2022

(51) Int. Cl. G06F 9/455; G06F 9/48

(52) U.S. Cl. CPC G06F 9/45558; G06F 9/4881; G06F 2009/45579

(57) ABSTRACT

A system and method for efficiently scheduling tasks to multiple endpoint devices are described. In various implementations, a computing system has a physical hardware topology that includes multiple endpoint devices and one or more general-purpose central processing units (CPUs). A virtualization layer is added between the hardware of the computing system and an operating system that creates a guest virtual machine (VM) with multiple endpoint devices. The guest VM utilizes a guest VM topology that is different from the physical hardware topology. The processor of an endpoint device that runs the guest VM accesses a table of latency information for one or more pairs of endpoints of the guest VM based on physical hardware topology, rather than based on the guest VM topology. The processor schedules tasks on paths between endpoint devices based on the table.

### BACKGROUND

### Description of the Relevant Art

A computing system has a physical hardware topology that includes at least multiple endpoint devices and one or more general-purpose central processing units (CPUs). In some designs, each of the endpoint devices is a graphics processing unit (GPU) that uses a parallel data processor, and the endpoint devices are used in non-uniform memory access (NUMA) nodes that utilize the endpoint devices to process tasks. A virtualization layer is added between the hardware of the computing system and an operating system that creates a guest virtual machine (VM) with multiple endpoint devices. The guest VM utilizes a guest VM topology that is different from the physical hardware topology. For example, the guest VM topology uses a single emulated root complex, which lacks the connectivity that is actually used in the physical hardware topology. Therefore, paths between endpoint devices are misrepresented in the guest VM topology.

The hardware of a processor of an endpoint device executes instructions of a device driver in the guest VM. When scheduling tasks, the device driver being executed by this processor of the endpoint device uses latency information between endpoint devices provided by the guest VM. For example, the guest VM being executed by the processor of the endpoint device generates an operating system (OS) call to determine the latencies. These latencies rely on the latency information based on the guest VM topology, rather than the physical hardware topology. Therefore, when executing the device driver, the processor schedules tasks with mispredicted latencies between nodes of the computing system such as between two processors located in the computing system. These mispredicted latencies between nodes result in an erroneous detection of a hung system, or result in scheduling that provides lower system performance.

In view of the above, efficient methods and systems for efficiently scheduling tasks to multiple endpoint devices are desired.

### BRIEF DESCRIPTION OF THE DRAWINGS

FIG. 1 is a generalized diagram of a computing system using virtual resources.

FIG. 2 is a generalized diagram of tables used for scheduling tasks on multiple endpoint devices using virtual resources.

FIG. 3 is a generalized diagram of a computing system using virtual resources.

FIG. 4 is a generalized diagram of tables used for scheduling tasks on multiple endpoint devices using virtual resources.

FIG. 5 is a generalized diagram of tables used for scheduling tasks on multiple endpoint devices using virtual resources.

FIG. 6 is a generalized diagram of tables used for scheduling tasks on multiple endpoint devices using virtual resources.

FIG. 7 is a generalized diagram of a computing system using virtual resources.

FIG. 8 is a generalized diagram of tables used for scheduling tasks on multiple endpoint devices using virtual resources.

FIG. 9 is a generalized diagram of a method for efficiently scheduling tasks on multiple endpoint devices using virtual resources.

FIG. 10 is a generalized diagram of a method for building, for one or more guest virtual machines (VMs), distance tables that rely on the physical hardware topology of the computing system, rather than a guest VM topology of any particular guest VM.

FIG. 11 is a generalized diagram of a method for providing a trimmed distance table to a particular guest VM where the trimmed distance table relies on the physical hardware topology of the computing system, rather than a guest VM topology of any particular guest VM.

While the invention is susceptible to various modifications and alternative forms, specific implementations are shown by way of example in the drawings and are herein described in detail. It should be understood, however, that drawings and detailed description thereto are not intended to limit the invention to the particular form disclosed, but on the contrary, the invention is to cover all modifications, equivalents and alternatives falling within the scope of the present invention as defined by the appended claims.

### DETAILED DESCRIPTION

In the following description, numerous specific details are set forth to provide a thorough understanding of the present invention. However, one having ordinary skill in the art should recognize that the invention might be practiced without these specific details. In some instances, well-known circuits, structures, and techniques have not been shown in detail to avoid obscuring the present invention. Further, it will be appreciated that for simplicity and clarity of illustration, elements shown in the figures have not necessarily been drawn to scale. For example, the dimensions of some of the elements are exaggerated relative to other elements.

Systems and methods for efficiently scheduling tasks to multiple endpoint devices are contemplated. In various implementations, multiple endpoint devices are placed in a computing system. The endpoint devices include one or more of a general-purpose microprocessor, a parallel data processor or processing unit, local memory, and one or more link or other interconnect interfaces for transferring data with other endpoint devices. In an implementation, each of the endpoint devices is a GPU that uses a parallel data processor, and the endpoint devices are used in non-uniform memory access (NUMA) nodes that utilize the endpoint devices to process tasks. Therefore, the computing system has a physical hardware topology that includes the multiple endpoint devices and at least one or more general-purpose CPUs and system memory. A software layer, such as a virtualization layer, is added between the hardware of the computing system and an operating system of one of the processors of the computing system such as a particular CPU. In various implementations, this software layer creates and runs at least one guest virtual machine (VM) in the computing system with the multiple endpoint devices.

A particular endpoint device runs a guest device driver of the guest VM. When executing this guest device driver of the guest VM, a processor (e.g., a microprocessor, a data parallel processor, other) of this particular endpoint device performs multiple steps. For example, the processor determines a task is ready for data transfer between two endpoint devices of the guest VM. The guest VM utilizes a guest VM topology that is different from the physical hardware topology. The processor accesses a distance table storing indications of distance or latency information corresponding to one or more pairs of endpoint devices of the guest VM based on physical hardware topology, rather than based on the guest VM topology. In various implementations, the table was built earlier by a topology manager and sent to the processor of the endpoint device for storage. In an implementation, the processor selects a pair of endpoint devices listed in the table that provide a smallest latency or smallest distance for data transfer based on the physical hardware topology. Following, the processor schedules the task on the selected pair of endpoint devices.

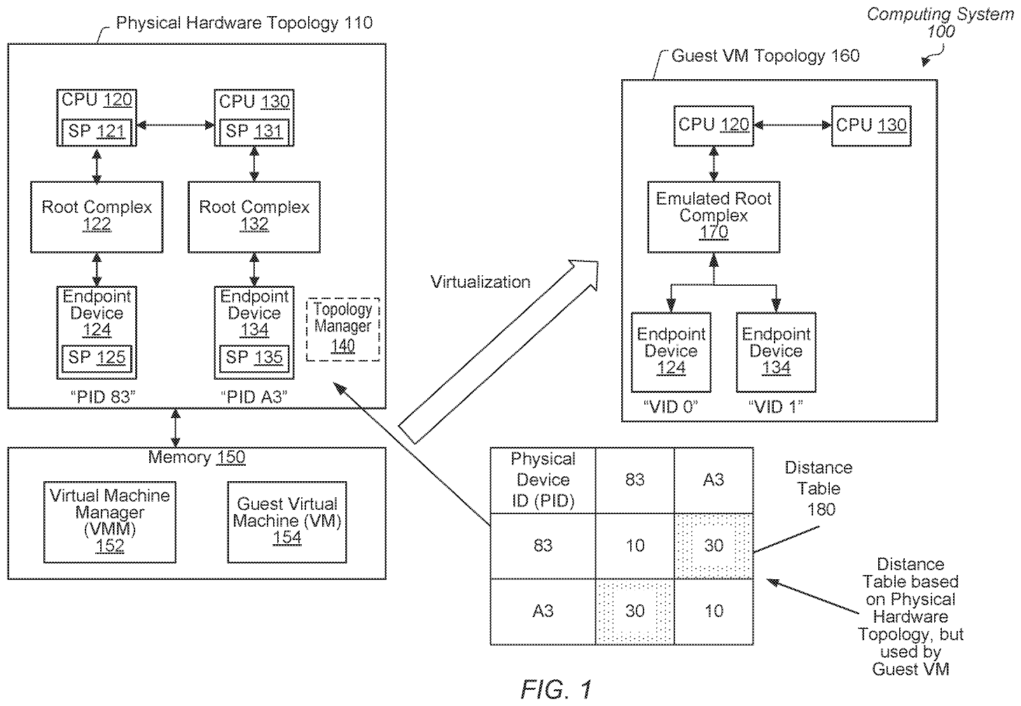

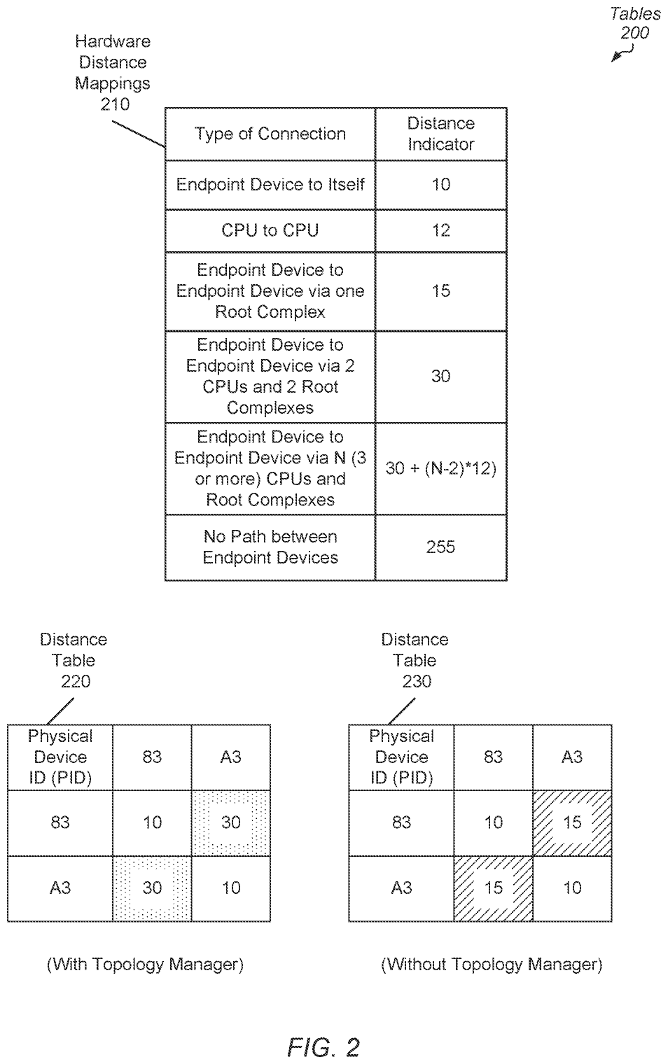

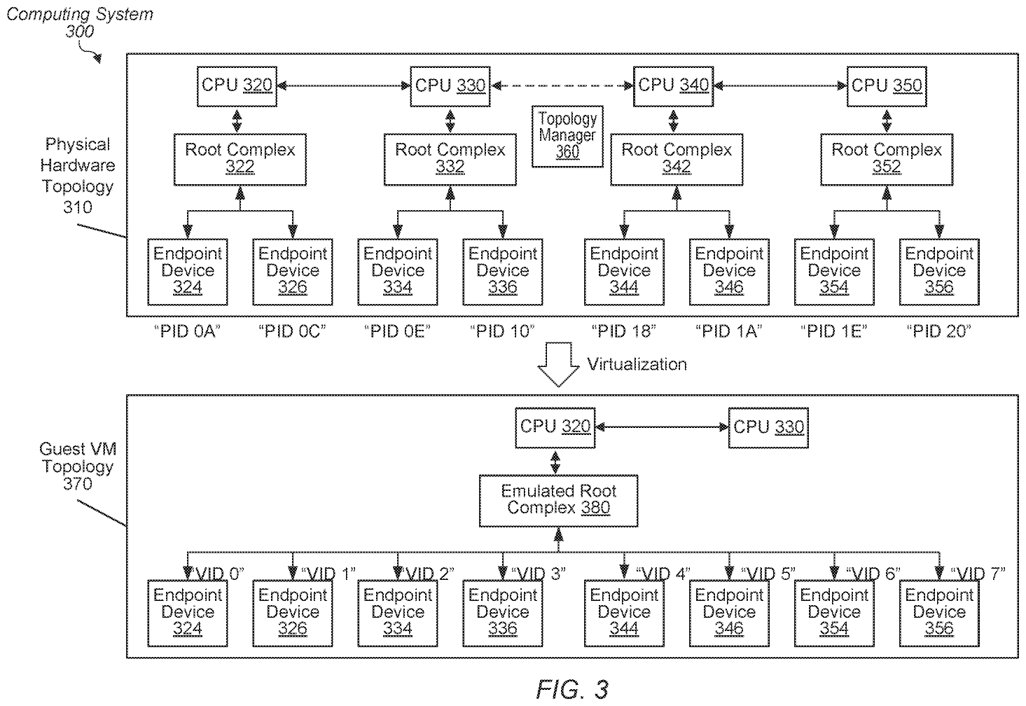

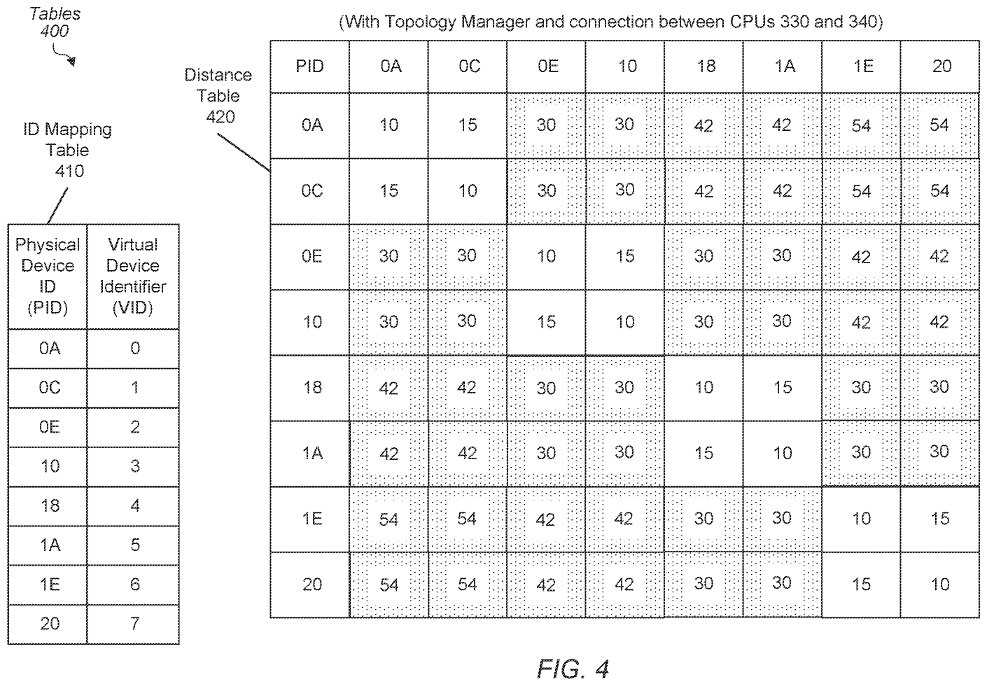

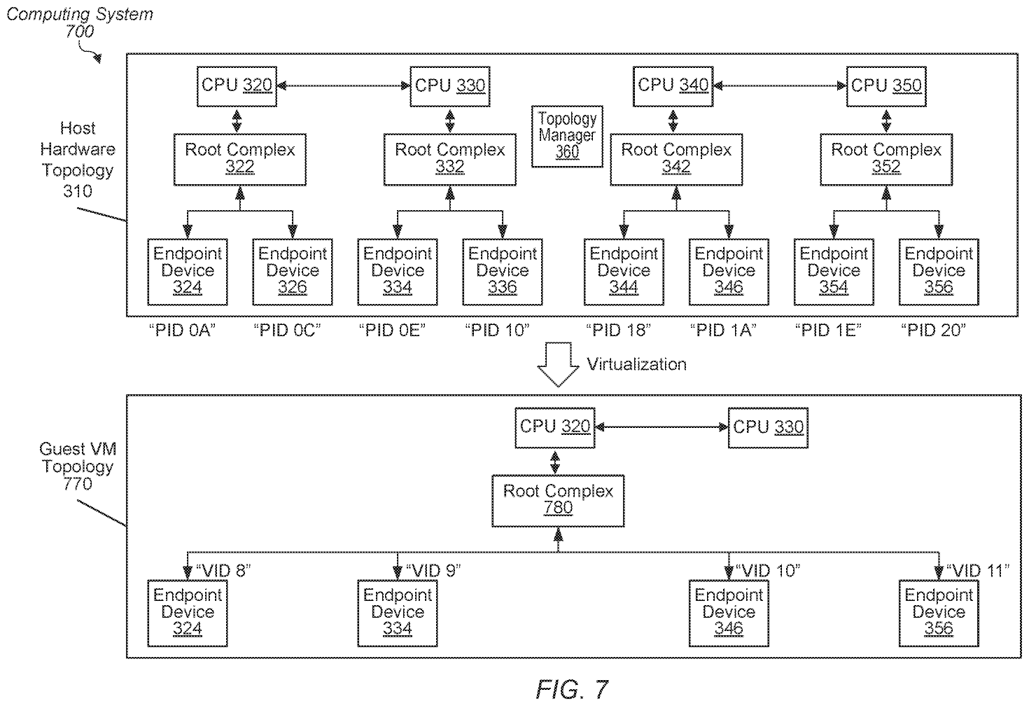

In the below description, FIG. 1 provides a computing system that includes multiple endpoint devices and uses a virtualization layer. The computing system uses a distance table for guest virtual machines (VMs) that is based on the physical hardware topology of the computing system, rather than a guest VM topology of any particular guest VM. The distance table is used for scheduling tasks by a device driver in a guest VM. A topology manager in the computing system supports this type of distance table. FIG. 2 illustrates the differences between a distance table that is based on the physical hardware topology of the computing system and another distance table that is based on a guest VM topology of a particular guest VM. FIGS. 3 and 7 describe computing systems that include multiple endpoint devices and use a virtualization layer. The hardware topologies of these computing systems further highlight the differences that can occur between the physical hardware topology of the computing system and another distance table that is based on a guest VM topology of a particular guest VM. FIGS. 4, 5, 6 and 8 illustrate the differences between distance tables that are based on different topologies such as a physical hardware topology and a guest VM topology.

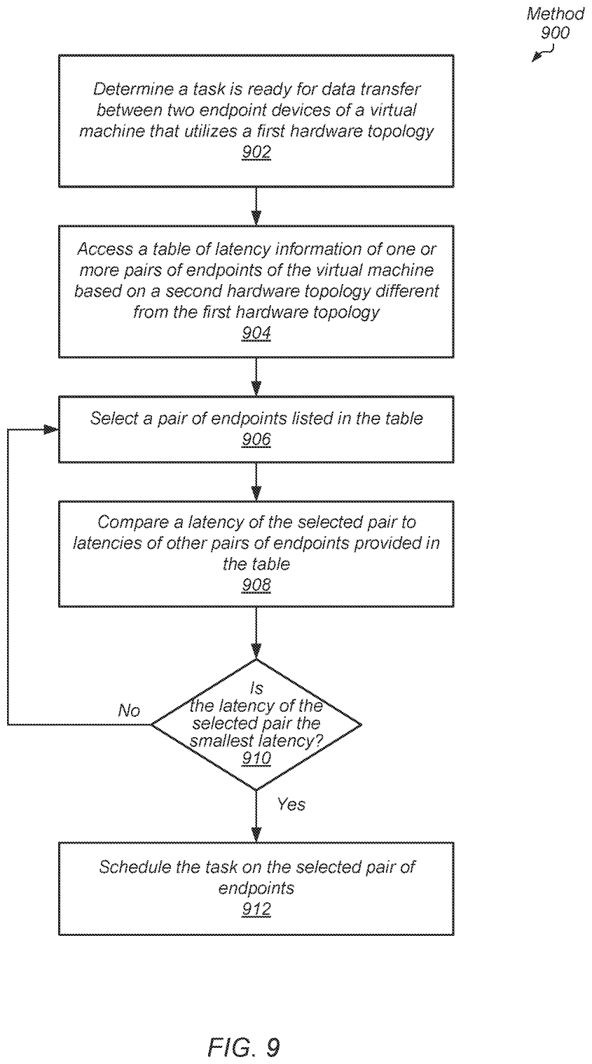

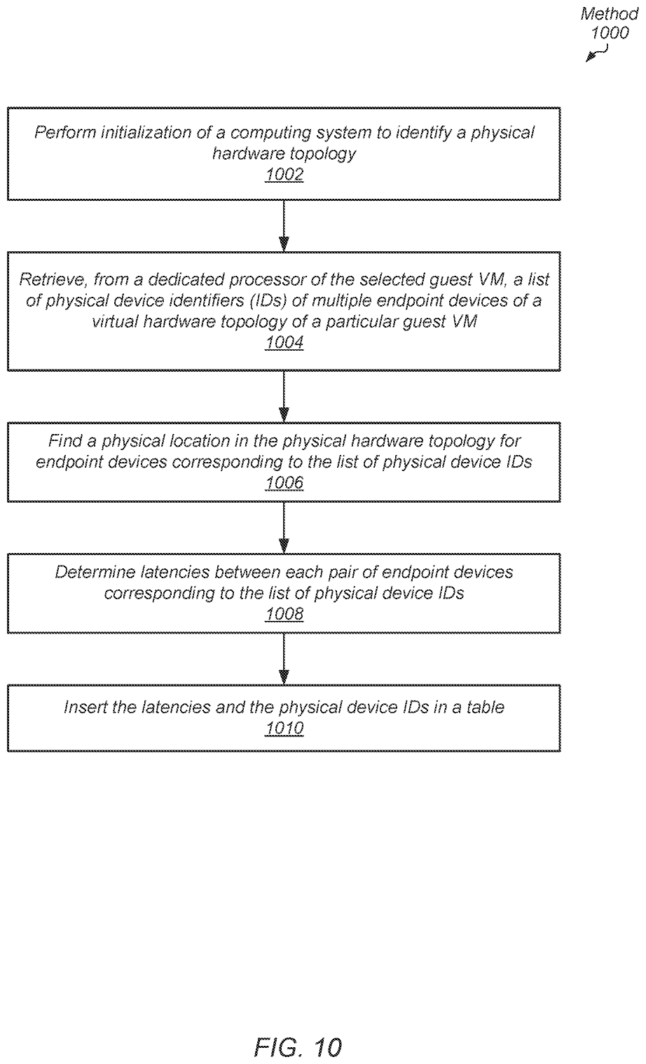

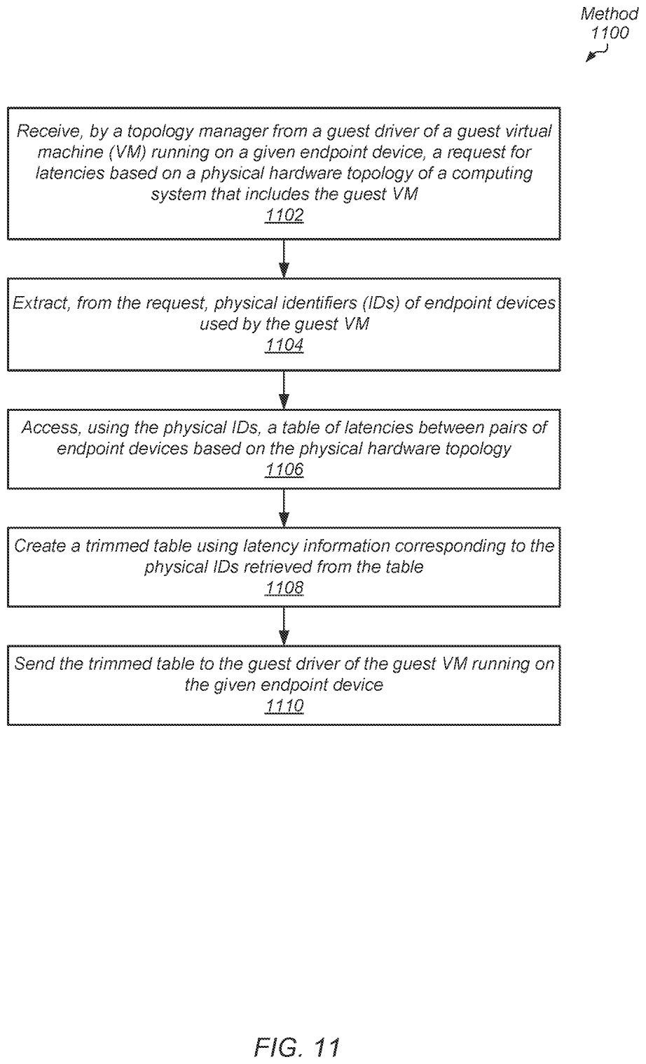

FIG. 9 describes a method for scheduling tasks in a guest VM based on a distance table that relies on the physical hardware topology of the computing system, rather than a guest VM topology of any particular guest VM. FIG. 10 provides a method for building, for one or more guest VMs, distance tables that rely on the physical hardware topology of the computing system, rather than a guest VM topology of any particular guest VM. FIG. 11 describes a method for providing a trimmed distance table to a particular guest VM where the trimmed distance table relies on the physical hardware topology of the computing system, rather than a guest VM topology of any particular guest VM.

Turning now to FIG. 1, a generalized diagram is shown of a computing system 100 using virtual resources. In the illustrated implementation, the computing system 100 includes the physical hardware topology 110, a memory 150 that stores at least a virtual machine manager (VMM) 152 used to generate at least one guest virtual machine (VM) 154. The guest VM 154 uses the guest VM topology 160. The physical hardware topology 110 uses a topology manager 140 to generate the distance table 180 that stores indications of distances or latencies between pairs endpoint devices. The indications of distances or latencies are based on the physical hardware topology 110, rather than the guest VM topology 160. A guest device driver (not shown) of the guest VM 154 uses the distance table 180 for scheduling tasks. A copy of the distance table 180 is stored in one or more of the CPUs 120 and 130 and the endpoint devices 124 and 134, or the copy is stored in a memory accessible by one or more of the CPUs 120 and 130 and the endpoint devices 124 and 134. The entries of the distance table 180 indicate the distances or latencies that are set based on the use of the topology manager 140. The shaded entries of the distance table 180 illustrate the distances or latencies that would differ if the distance table 180 was generated based on the guest VM topology 160, rather than the physical hardware topology 110. The actual, differing values of these shaded entries are described later in the description of the tables 200 (of FIG. 2).

In an implementation, the physical hardware topology 110 includes hardware circuitry such as general-purpose central processing units (CPUs) 120 and 130, root complexes 122 and 132, and endpoint devices 124 and 134. Additionally, the physical hardware topology 110 includes the topology manager 140. The endpoint devices 124 and 134 include one or more of a general-purpose microprocessor, a parallel data processor or processing unit, local memory, and one or more link or other interconnect interfaces for transferring data with one another and with the CPUs 120 and 130 via the root complexes 122 and 132. In an implementation, each of the endpoint devices 124 and 134 is a graphics processing unit (GPU) that uses a parallel data processor. In another implementation, one or more of the endpoint devices is another type of parallel data processor such as a digital signal processor (DSP), a custom application specific integrated circuit (ASIC), or other. In various implementations, the endpoint devices 124 and 134 are used in non-uniform memory access (NUMA) nodes that utilize the endpoint devices 124 and 134 to process tasks.

The topology manager 140 generates the distance table 180 that stores indications of distances or latencies between pairs of endpoint devices. The indications of distances or latencies are based on the physical hardware topology 110, rather than the guest VM topology 160. In some implementations, the indication of distance or latency is a non-uniform memory access (NUMA) distance between two nodes such as between two different processors, between a particular processor and a particular memory, or other. The NUMA distance can be indicated by a PCIe locality weight, an input/output (I/O) link weight, or other. Typically, as the weight lowers in value, the shorter is the distance between two nodes and the smaller is the latency between the two nodes. Other indications of distance and latency are possible and contemplated. As used herein, a “distance table” can be used interchangeably with a “latency table.”

In some implementations, the topology manager 140 determines a value for a particular endpoint device, using a physical identifier (ID), that determines a location of the endpoint device in the physical hardware topology 110 of the computing system 100. In an implementation, the topology manager 140 determines a BDF (or B/D/F) value based on the PCI standard that locates the particular endpoint device in the physical hardware topology 110. The BDF value stands for Bus, Device, Function, and in the PCI standard specification, it is a 16-bit value. Based on the PCI standard, the 16-bit value includes 8 bits for identifying one of 256 buses, 5 bits for identifying one of 32 devices on a particular bus, and 3 bits for identifying a particular function of 8 functions on a particular device. Other values for identifying a physical location of the endpoint device in the physical hardware topology are also possible and contemplated. Following, the topology manger 140 then determines an indication of latency or distance between pairs of endpoint devices using the identified physical locations. For example, the topology manager 140 determines NUMA distances that the topology manager 140 places in a copy of the distance table 180.

Each of the CPUs 120 and 130 processes instructions of a predetermined algorithm. The processing includes fetching instructions and data, decoding instructions, executing instructions and storing results. In an implementation, the CPUs 120 and 130 use one or more processor cores with circuitry for executing instructions according to a predefined general-purpose instruction set architecture (ISA). Each of the root complexes 122 and 132 provides connectivity between a respective one of the CPUs 120 and 130 and one or more endpoint devices. As used herein, an “endpoint device” can also be referred to as an “endpoint.” For example, endpoint devices 124 and 134 can also be referred to as endpoints 124 and 134. In the illustrated implementation, each of the root complexes 122 and 132 is connected to a single endpoint, but in other implementations, one or more of the root complexes 122 and 132 is connected to multiple endpoints.

As used herein, a “root complex” refers to a communication switch fabric that is a root near a corresponding CPU of an inverted tree hierarchy that is capable of communicating with multiple endpoints. For example, the root complex is connected to the corresponding CPU through a local bus, and the root complex generates transaction requests on behalf of the corresponding CPU to send to one or more multiple endpoint devices that are connected via ports to the root complex. The root complex includes one or more queues for storing requests and responses corresponding to various types of transactions such as messages, commands, payload data, and so forth. The root complex also includes circuitry for implementing switches for routing transactions and for supporting a particular communication protocol. One example of a communication protocol is the Peripheral Component Interconnect Express (PCIe) communication protocol.

In various implementations, each of the endpoints 124 and 134 includes a parallel data processing unit, which utilizes a single instruction multiple word (SIMD) micro-architecture. As described earlier, in some implementations, the parallel data processing unit is a graphics processing unit (GPU). The SIMD micro-architecture uses multiple compute resources with each of the compute resources having a pipelined lane for executing a work item of many work items. Each work unit is a combination of a command and respective data. One or more other pipelines uses the same instructions for the command, but operate on different data. Each pipelined lane is also referred to as a compute unit.

The parallel data processing unit of the endpoint devices 124 and 134 uses various types of memories such as a local data store shared by two or more compute units within a group as well as a command cache and a data cache shared by each of the compute units. Local registers in register files within each of the compute units are also used. The parallel data processing unit additionally uses secure memory for storing secure programs and secure data accessible by only a controller within the parallel data processing unit. The controller is also referred to as a command processor within the parallel data processing unit. In various implementations, the command processor decodes requests to access information in the secure memory and prevents requestors other than itself from accessing content stored in the secure memory. For example, a range of addresses in on-chip memory within the parallel data processing unit is allocated for providing the secure memory. If an address within the range is received, the command processor decodes other attributes of the transaction, such as a source identifier (ID), to determine whether or not the request is sourced by the command processor.

The memory 150 is any suitable memory device. Examples of the memory devices are dynamic random access memories (DRAMs), synchronous DRAMs (SDRAMs), static RAM, three-dimensional (3D) integrated DRAM, and so forth. It is also possible and contemplated that the physical hardware topology 110 includes one or more of a variety of other processing units. The multiple processing units can be individual blocks or individual dies on an integrated circuit (IC), such as a system-on-a-chip (SOC). Alternatively, the multiple processing units can be individual blocks or individual dies within a package, such as a multi-chip module (MCM).

A software layer, or virtualization layer, is added between the hardware of the physical hardware topology 110 and an operating system of one of the CPUs 120 and 130. In one instance, this software layer runs on top of a host operating system and spawns higher level guest virtual machines (VMs). This software layer monitors corresponding VMs and redirects requests for resources to appropriate application program interfaces (APIs) in the hosting environment. This type of software layer is referred to as a virtual machine manager (VMM) such as VMM 152 stored in memory 150. A virtual machine manager is also referred to as a virtual machine monitor or a hypervisor. The virtualization provided by the VMM 152 allows one or more guest VMs, such as guest VM 154, to use the hardware resources of the parallel data processors of the endpoint devices 124 and 134. Each guest VM executes as a separate process that uses the hardware resources of the parallel data processor.

In an implementation, the VMM 152 is used to generate the guest VM 154 that uses the guest VM topology 160. A guest device driver that runs (or executes) as a process on one of the endpoint devices 124 and 134 along with a guest operating system to implement the guest VM 154 uses the hardware of the CPUs 120 and 130. In addition, the guest VM 154 uses the hardware of the endpoint devices 124 and 134. However, rather than use the hardware of the root complexes 122 and 132, the guest VM 154 uses an emulated root complex 170. Therefore, without help from the topology manager 140, the guest device driver of the guest VM 154 is unaware of the true connectivity between the endpoints 124 and 134. For example, the connectivity in the guest VM topology 160 uses the single emulated root complex 170 between them. However, in the physical hardware topology 110, the true, physical connectivity between the endpoints 124 and 134 connects to each of the root complexes 122 and 132 and connects to each of the CPUs 120 and 130 via the root complexes 122 and 132.

As described earlier, the topology manager 140 generates the indications of distances or latencies stored in the distance table 180 based on the physical hardware topology 110, rather than the guest VM topology 160. When executed by one of the endpoint devices 124 and 134, the guest VM 154 uses a copy of the distance table 180 when scheduling tasks. As described earlier, a copy of the distance table 180 is stored in one or more of the CPUs 120 and 130 and the endpoint devices 124 and 134, or the copy is stored in a memory accessible by one or more of the CPUs 120 and 130 and the endpoint devices 124 and 134.

In one implementation, the topology manager 140 is implemented by a dedicated processor. An example of the dedicated processor is a security processor. In some implementations, the security processor is a dedicated microcontroller within an endpoint device that includes one or more of a microprocessor, a variety of types of data storage, a memory management unit, a dedicated cryptographic processor, a direct memory access (DMA) engine, and so forth. The interface to the security processor is carefully controlled, and in some implementations, direct access to the security processor by external devices is avoided. Rather, in an implementation, communication with the security processor uses a secure mailbox mechanism where external devices send messages and requests to an inbox. The security processor determines whether to read and process the messages and request, and sends generated responses to an outbox. Other communication mechanisms with the security processor are also possible and contemplated.

In other implementations, the functionality of the topology manager 140 is implemented across multiple security processors such as a security processor of the endpoint device 124 and another security processor of the endpoint device 134 where the endpoint devices 124 and 134 are used in the guest VM topology 160. For example, the endpoints 124 and 134 include the security processors (SPs) 125 and 135, respectively. In another implementation, the functionality of the topology manager 140 is implemented by one or more of the CPUs 120 and 130. In yet other implementations, the functionality of the topology manager 140 is implemented by a security processor of one of the CPUs 120 and 130 that runs the VMM 152. For example, the CPU 120 and 130 include the security processors (SPs) 121 and 131, respectively. In further implementations, the functionality of the topology manager 140 is implemented by a combination of one or more of these security processors 121, 131, 125 and 135.

Regardless of the particular combination of hardware selected to perform the functionality of the topology manager 140, it is noted that the functionality of the topology manager 140 is also implemented by the selected combination of hardware executing instructions of one or more of a variety of types of software. The variety of types of software include a host device driver running on one of the CPUs 120 and 130, a particular application running on one of the CPUs 120 and 130, a device driver within the guest VM 154, the guest VM 154, a variety of types of firmware, and so on.

In an implementation, the distance table 180 includes indications of distances or latencies between pairs of endpoint devices. A single pair of endpoint devices 124 and 134 is shown as an example, but in other implementations, each of the physical hardware topology 110 and the guest VM topology 160 uses multiple pairs of endpoint devices. As shown, the distance table 180 includes physical identifiers (IDs) of the endpoint devices 124 and 134 as well as corresponding indications of latencies. In the illustrated implementation, the endpoint 124 has the physical device identifier (PID) 83, which is a hexadecimal value, and the virtual device identifier (VID) 0. The endpoint 134 has a PID value of A3, which is also a hexadecimal value, and a VID value of 1. The shaded entries of the distance table 180 indicate the distances or latencies that are set based on the use of the topology manager 140. The shaded entries illustrate the distances or latencies that would differ if the distance table 180 was generated based on the guest VM topology 160, rather than the physical hardware topology 110. The differing values of these entries are described below in the upcoming description of the tables 200 (of FIG. 2).

Referring to FIG. 2, a generalized diagram is shown of tables 200 used for scheduling tasks on multiple endpoint devices using virtual resources. The tables 200 include the hardware distance mappings 210, the distance table 220 that is generated with the use of a topology manager, and the distance table 230 that is generated without the use of the topology manager. The hardware distance mappings 210 (or mappings 210) identify a particular type of connection within a physical hardware topology and a corresponding indication of a latency (or distance indicator) for data to be transferred across the connection. As used herein, an “indication of latency” between two nodes in a computing system can also be referred to as an “indication of distance” between the two nodes. As described earlier, in some implementations, the indication of distance or latency is a non-uniform memory access (NUMA) distance between two nodes such as between two different processors, between a particular processor and a particular memory, or other. The NUMA distance can be indicated by a PCIe locality weight, an input/output (I/O) link weight, or other. Typically, as the weight lowers in value, the shorter is the distance between two nodes and the lower is the latency between the two nodes. Other indications of distance and latency are possible and contemplated.

The range of latencies in the mappings 210 is shown as a smallest value of 10 and a largest value of 255. The smallest indication of latency of 10 corresponds to a connection that includes an endpoint device sending a transaction to itself. The largest indication of latency of 255 corresponds to a connection that does not exist. In other words, there is no path between a particular pair of endpoint devices. A connection, or path, for data transfer between a pair of CPUs connected to one another is shown to have an indication of latency of 12. A path for data transfer between a pair of endpoint devices with a single root complex between them is shown to have an indication of latency of 15. A path for data transfer between a pair of endpoint devices with two root complexes and two CPUs between them is shown to have an indication of latency of 30. An example of this path is provided earlier regarding the path between the endpoint devices 124 and 134 (of FIG. 1).

Rather than show each type of path as a physical hardware topology grows and becomes more complex, an entry of the mappings 210 shows a formula that can be potentially used. For example, as the number of root complexes and corresponding endpoint devices grows, in some cases, the indication of latency grows based on the formula 30+(N−2)×12. In other words, when a first endpoint sends a transaction to a second endpoint across 4 CPUs and 2 root complexes, the indication of latency is 30+(4-2)×12, or 54. The distance tables 220 and 230 correspond to the physical hardware topology 110 and the guest VM topology 160 (of FIG. 1). With the use of a topology manager, the distance table 220 includes the same values found in the earlier distance table 180. For example, each of the endpoint devices 124 and 134 have an indication of latency of 10 when sending transactions to themselves. When sending transactions to one another, the indication of latency is 30.

Without the use of the topology manager, the endpoint devices, such as endpoint devices 124 and 134 of the computing system 100 (of FIG. 1), rely on the guest VM topology 160, rather than the physical hardware topology 110. Therefore, incorrect, or erroneous, indications of latency are used when scheduling tasks. For example, the shaded entries of the distance table 230 provide an indication of latency of 15, rather than 30, when the endpoint devices 124 and 134 of the computing system 100 send transactions to one another. This incorrect indication of latency is stored in a simulated system basic input/output software (SBIOS) for the guest VM. For example, when a guest device driver in the guest VM makes a call an operating system (OS) application programming interface (API) to obtain the indications of latency, the guest OS kernel code of the guest VM retrieves the indications of latency from the SBIOS. In an implementation, the indications of latency are stored in an Advanced Configuration and Power Interface (ACPI) table. However, this information relies on the guest VM topology 160, rather than the physical hardware topology 110. Without the help of the topology manager, the indications of latency are not updated to the values stored in the distance table 220.

Turning now to FIG. 3, a generalized diagram is shown of a computing system 300 using virtual resources. In the illustrated implementation, the computing system 300 includes the physical hardware topology 310. A memory that stores at least a virtual machine manager (VMM) is not shown for ease of illustration. One of the CPUs 320, 330, 340 and 350 runs the VMM to generate at least one guest virtual machine (VM). The guest VM uses the guest VM topology 370. In an implementation, the physical hardware topology 310 includes hardware circuitry such as the CPUs 320, 330, 340 and 350, the root complexes 322, 332, 342, and 352, and the endpoint devices 324, 326, 334, 336, 344, 346, 354 and 356. In various implementations, the CPUs, the root complexes, and the endpoint devices of the physical hardware topology 310 include the components and the functionality described earlier for the CPUs, the root complexes, and the endpoint devices of the physical hardware topology 110 (of FIG. 1). In some implementations, there is a path between CPUs 330 and 340, whereas, in other implementations, there is no path between CPUs 330 and 340. Although a particular number and type of components and connectivity are show, it is understood that another number and type of components and connectivity are used in other implementations.

A guest device driver that runs as a process on one of the endpoint devices 324-356 along with a guest operating system to implement the guest VM uses the hardware of the CPUs 320 and 330. In addition, the guest VM uses the hardware of the endpoint devices 324-356. However, rather than use the hardware of the root complexes 322-352, the guest VM uses an emulated root complex 380. The virtual device identifiers (VIDs) 0-7 are assigned to the endpoint devices 324-356. The corresponding physical device IDs (PIDs) are shown in the physical hardware topology 310. In various implementations, the topology manager 360 includes the functionality of the topology manager 140, and additionally, the topology manager 360 is implemented by one of a variety of implementations described earlier for the topology manager 140. The topology manager 360 performs steps to generate a distance table based on the physical hardware topology 310, rather than the guest VM topology 370. The details of this distance table are provided in the below description.

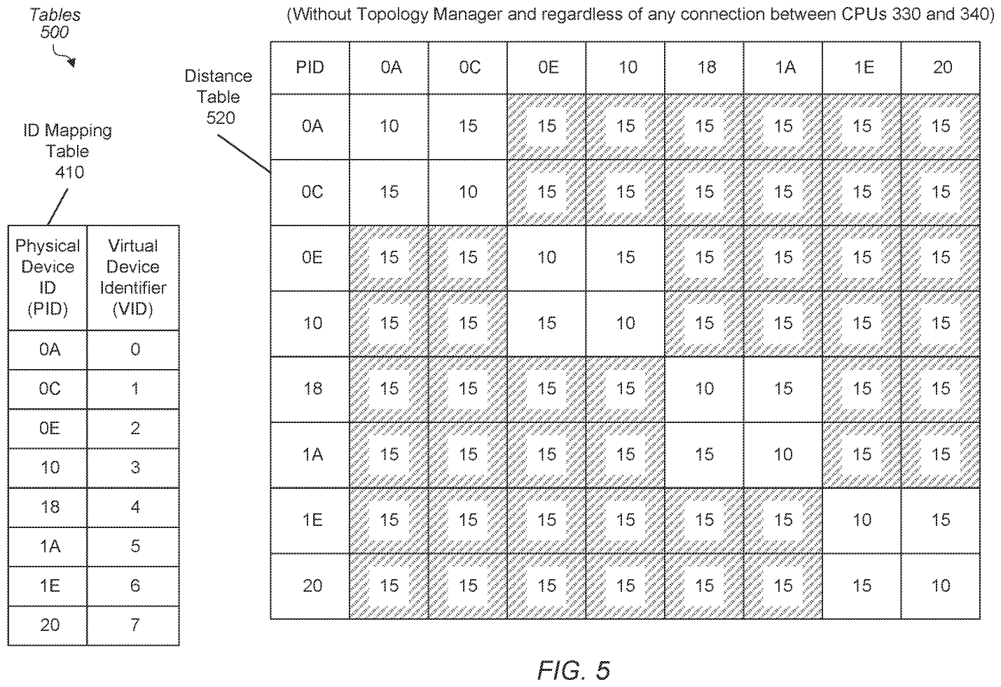

Referring to FIG. 4, a generalized diagram is shown of tables 400 used for scheduling tasks on multiple endpoint devices using virtual resources. The tables 400 include the device identifier (ID) mapping table 410 and the distance table 420 that is generated with the use of a topology manager. The distance table 420 is associated with a version of the physical hardware topology 310 (of FIG. 3) that includes a path between the CPUs 330 and 340. In an implementation, the distance table 420 (as well as the distance tables 520, 620 and 820 of FIGS. 5-6 and 8) uses the indications of latencies described earlier for the hardware distance mappings 210 (of FIG. 2). However, in other implementations, other indications of latency are used.

Each entry of the ID mapping table 410 stores a mapping between a physical device ID (PID) of an endpoint device and a corresponding virtual device identifier (VID). The values of these IDs are shown in the computing system 300 (of FIG. 3). The distance table 420 uses the PIDs of endpoint devices to provide the indications of latencies between pairs of endpoint devices used in a guest VM. The indications of latencies are based on a physical hardware topology, rather than a guest VM topology. The shaded entries of the distance table 420 indicate the latencies that are adjusted based on the use of the topology manager (such as topology manager 140 of FIG. 1 and topology manager 360 of FIG. 3). For example, the shaded entries of the distance table 420 provide an indication of latency of 42, rather than 15, when the endpoint devices with PIDs 0A and 18 of the computing system 300 send transactions to one another. It is also noted that when the device driver of the guest VM running on an endpoint device schedules data transfer tasks for the endpoint with PID 20, the device driver selects the endpoint with PID 1E. As can be seen from the distance table 420, this pair of endpoints have an indication of latency of 15, whereas, other pairings with other endpoints provide indications of latency of 30 (e.g., endpoints with PIDs 18 and 1A), indications of latency of 42 (e.g., endpoints with PIDs 0E and 10), and indications of latency of 54 (e.g., endpoints with PIDs 0A and 0C).

Turning now to FIG. 5, a generalized diagram is shown of tables 500 used for scheduling tasks on multiple endpoint devices using virtual resources. The tables 500 include the mapping table 410 and the distance table 520 that is generated without the use of a topology manager. The distance table 520 uses the PIDs of endpoint devices to provide the indications of latencies between pairs of endpoint devices used in a guest VM. In contrast to the earlier distance table 420, the indications of latencies in the distance table 520 are based on a guest VM topology, rather than a physical hardware topology. The shaded entries of the distance table 520 indicate the latencies that are not adjusted based on the use of the topology manager providing latencies relying on the physical hardware topology of the computing system. Therefore, the shaded entries of the distance table 520 provide an indication of latency of 15, rather than 54, when the endpoint devices with PIDs 0C and 20 of the computing system 300 send transactions to one another. This indication of latency with a value of 15 is based on the use of an emulated root complex in a guest VM topology of the computing system, rather than the actual physical, hardware topology of the computing system. Comparing the latency information between distance table 420 (of FIG. 4) and distance table 520, it can be seen that the distance table 520 lacks useful information regarding the actual physical, hardware topology and corresponding latencies (or distances) between two nodes such as between two endpoints. As a result, the table 520 should be avoided when scheduling tasks on the guest VM.

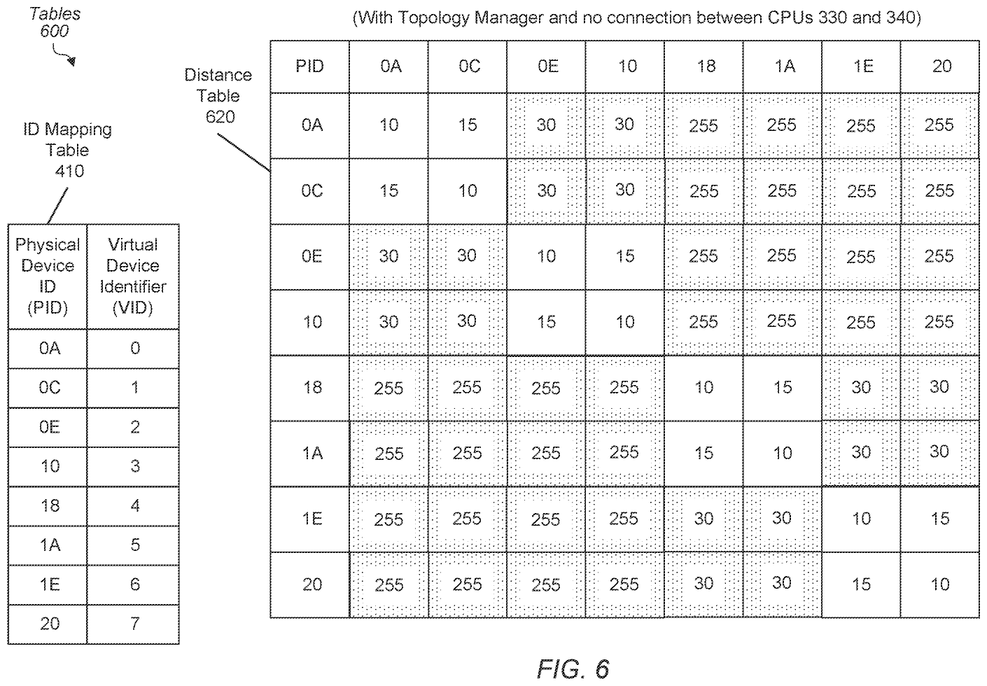

Referring to FIG. 6, a generalized diagram is shown of tables 600 used for scheduling tasks on multiple endpoint devices using virtual resources. The tables 600 include the device identifier (ID) mapping table 410 and the distance table 620 that is generated with the use of a topology manager. The distance table 620 is associated with a version of the physical hardware topology 310 (of FIG. 3) that does not include a path between the CPUs 330 and 340. The distance table 620 uses the PIDs of endpoint devices to provide the indications of latencies between pairs of endpoint devices used in a guest VM. The indications of latencies are based on a physical hardware topology, rather than a guest VM topology. The shaded entries of the distance table 620 indicate the latencies that are adjusted based on the use of the topology manager (such as topology manager 360 of FIG. 3). For example, the shaded entries of the distance table 620 provide an indication of latency of 255 (or no path), rather than 15, when the endpoint devices with PIDs 10 and 1A of the computing system 300 attempt to send transactions to one another. In such a case, the guest device driver is able to avoid attempting such a path, and instead, search for another endpoint device for transferring data.

Turning now to FIG. 7, a generalized diagram is shown of a computing system 700 using virtual resources. In the illustrated implementation, the computing system 700 includes the physical hardware topology 310. Here, there is no path between CPUs 330 and 340. Similar system components as described above are numbered identically. One of the CPUs 320, 330, 340 and 350 runs the VMM (not shown) to generate at least one guest virtual machine (VM). The guest VM uses the guest VM topology 770. A guest device driver that runs as a process on one of the endpoint devices 324, 334, 346 and 356 along with a guest operating system to implement the guest VM uses the hardware of the CPUs 320 and 330. In addition, the guest VM uses the hardware of the endpoint devices 324, 334, 346 and 356, rather than all of the endpoints 324-356. Rather than use the hardware of the root complexes 322-352, the guest VM uses an emulated root complex 780.

The virtual device identifiers (VIDs) 8-11 are assigned to the endpoint devices 324, 334, 346 and 356. The corresponding physical device IDs (PIDs) are shown in the physical hardware topology 310. The topology manager 360 performs steps to generate a distance table based on the physical hardware topology 310, rather than the guest VM topology 770. The details of this distance table are provided in the below description.

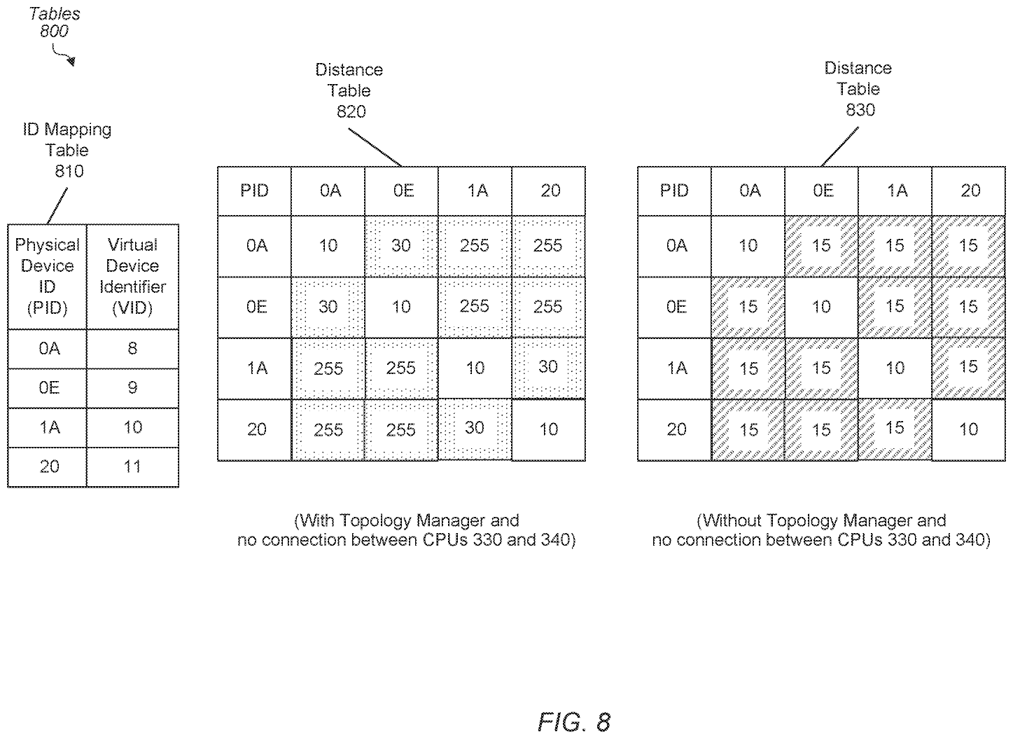

Referring to FIG. 8, a generalized diagram is shown of tables 800 used for scheduling tasks on multiple endpoint devices using virtual resources. The tables 800 include the device identifier (ID) mapping table 810, the distance table 820 that is generated with the use of a topology manager, and the distance table 830 that is generated without the use of the topology manager. The distance table 820 is associated with a version of the physical hardware topology 310 (of FIG. 7) that reflects no path between the CPUs 330 and 340. Similar to the earlier mapping table 410, each entry of the ID mapping table 810 (or mapping table 810) stores a mapping between a physical device ID (PID) of an endpoint device and a corresponding virtual device identifier (VID). The values of these IDs are shown in the computing system 700 (of FIG. 7).

The distance table 820 uses the PIDs of endpoint devices to provide the indications of latencies between pairs of endpoint devices used in a guest VM. The indications of latencies in the distance table 820 are based on a physical hardware topology, rather than a guest VM topology. In contrast, the indications of latencies in the distance table 830 are based on a guest VM topology, rather than a physical hardware topology. The shaded entries of the distance tables 820 and 830 indicate the latencies that are adjusted based on the use of the topology manager (such as topology manager 360 of FIG. 7). For example, the shaded entries of the distance table 820 provide an indication of latency of 255 (no path), rather than 15, when the endpoint devices with PIDs 0E and 1A of the computing system 700 attempt to send transactions to one another. In such a case, the guest device driver is able to avoid attempting such a path, and instead, search for another endpoint device for transferring data.

Turning now to FIG. 9, a generalized diagram is shown of a method 900 for efficiently scheduling tasks on multiple endpoint devices using virtual resources. For purposes of discussion, the steps in this implementation (as well as in FIGS. 10-11) are shown in sequential order. However, in other implementations some steps occur in a different order than shown, some steps are performed concurrently, some steps are combined with other steps, and some steps are absent.

Multiple endpoint devices are placed in a computing system. The endpoint devices include one or more processors, local memory, and one or more link or other interconnect interfaces for transferring data with other endpoint devices. In an implementation, each of the endpoint devices is a GPU that uses a parallel data processor. In some implementations, the GPUs are used in non-uniform memory access (NUMA) nodes that utilize the GPUs to process tasks. The computing system also includes one or more general-purpose CPUs, system memory, and one or more of a variety of peripheral devices besides the endpoint devices. It is also possible and contemplated that the computing system includes one or more of a variety of other processing units.

A software layer is added between the hardware of the computing system and an operating system of one of the processors of the computing system such as a particular CPU. In various implementations, this software layer creates and runs at least one guest virtual machine (VM) in the computing system with the multiple endpoint devices. A particular endpoint device runs a guest device driver of the guest VM. When executing this guest device driver, a processor of this particular endpoint device determines a task is ready for data transfer between two endpoint devices of the guest VM that utilizes a first hardware topology (block 902). The processor accesses a distance table of latency information of one or more pairs of endpoints of the guest VM based on a second hardware topology different from the first hardware topology (block 904). In an implementation, the first hardware topology uses an emulated root complex, whereas, the second hardware topology includes the actual physical root complexes and corresponding connections. In various implementations, the distance table was built earlier by a topology manager (such as topology manager 140 of FIG. 1 and topology manager 360 of FIG. 3). In an implementation, the topology manager sent this distance table to at least this particular endpoint device for storage. When executing the device driver, the processor performs multiple steps. For example, the processor selects a pair of endpoints listed in the distance table (block 906).

The processor compares a latency of the selected pair to latencies of other pairs of endpoints provided in the distance table (block 908). If the latency of the selected pair is not the smallest latency (“no” branch of the conditional block 910), then the control flow of method 900 returns to block 906 where the processor selects a next pair of endpoints. If the latency of the selected pair is the smallest latency (“yes” branch of the conditional block 910), then the processor schedules the task on the selected pair of endpoints (block 912). Therefore, in an implementation, the processor selects the pair of endpoints based on determining a particular latency of the latency information corresponding to the pair of endpoints is less than any latency of the latency information corresponding to each other pair of endpoints of the second hardware topology.

For each of the methods 1000 and 1100 (of FIG. 10 and FIG. 11), in some implementations, a particular CPU performs the initialization and identifies physical IDs of components. In various implementations, software virtualization layer is added between the hardware of the computing system and an operating system of one of the processors of the computing system such as a particular CPU. In an implementation, this virtualization layer is a VMM that supports one or more guest VMs. In one implementation, a topology manager of the computing system includes the functionality of the topology managers 140 and 360 (of FIGS. 1 and 3), and additionally, the topology manager is implemented by one of a variety of implementations described earlier for the topology manager 140 (of FIG. 1). Referring to FIG. 10, a generalized diagram is shown of a method 1000 for building, for one or more guest VMs, distance tables that rely on the physical hardware topology of the computing system, rather than a guest VM topology of any particular guest VM. A computing system performs initialization and identifies a physical hardware topology (block 1002).

The endpoint device that runs a particular guest VM retrieves a list of physical device identifiers (IDs) of multiple endpoint devices of a virtual hardware topology of the guest VM (block 1004). Within this endpoint device, in an implementation, one or more of a security processor and a device driver or an application running on a separate processor accesses a mapping table that stores mappings between virtual IDs of endpoint devices used in the guest VM and the corresponding physical IDs. In another implementation, the security processor of this endpoint device retrieves the physical IDs from a CPU that runs a host driver or an application that accesses mappings between the virtual IDs and the physical IDs. One of the various implementations of the topology manager finds a physical location in the physical hardware topology for endpoint devices corresponding to the list of physical device IDs (block 1006). Further details of an indication of this physical location are provided in the below description. The topology manager determines latencies between each pair of endpoint devices corresponding to the list of physical device IDs (block 1008). As described earlier, an example of an indication of latency is a NUMA distance. The topology manager inserts the indications of latencies and the physical device IDs in a table (block 1010). Since the physical IDs of only the endpoint devices used by the guest VM are used, this table is a trimmed distance table that includes latency information only for the endpoint devices used by the guest VM. The above steps performed in blocks 1004-1010 can be repeated for each guest VM used in the computing system.

In some implementations, the topology manager determines a value for a particular endpoint device, using the physical ID, that determines a location of the endpoint device in the physical hardware topology of the computing system. For example, the topology manager determines a BDF (or B/D/F) value based on the PCI standard that locates the particular endpoint device in the physical hardware topology. The BDF value stands for Bus, Device, Function, and in the PCI standard specification, it is a 16-bit value. Based on the PCI standard, the 16-bit value includes 8 bits for identifying one of 256 buses, 5 bits for identifying one of 32 devices on a particular bus, and 3 bits for identifying a particular function of 8 functions on a particular device. Other values for identifying a physical location of the endpoint device in the physical hardware topology are also possible and contemplated.

Turning now FIG. 11, a generalized diagram is shown of a method 1100 for providing a trimmed distance table to a particular guest VM where the trimmed distance table relies on the physical hardware topology of the computing system, rather than a guest VM topology of any particular guest VM. A topology manager receives, from a guest driver of a guest virtual machine (VM) running on a given endpoint device, a request for latencies based on a physical hardware topology of a computing system that includes the guest VM (block 1102). The topology manager extracts, from the request, physical identifiers (IDs) of endpoint devices used by the guest VM (block 1104).

The topology manager accesses, using the physical IDs, a table of latencies between pairs of endpoint devices based on the physical hardware topology (block 1106). The topology manager creates a trimmed table using latency information corresponding to the physical IDs retrieved from the table (block 1108). The topology manager sends the trimmed table to the guest driver of the guest VM running on the given endpoint device (block 1110).

It is noted that one or more of the above-described implementations include software. In such implementations, the program instructions that implement the methods and/or mechanisms are conveyed or stored on a computer readable medium. Numerous types of media which are configured to store program instructions are available and include hard disks, floppy disks, CD-ROM, DVD, flash memory, Programmable ROMs (PROM), random access memory (RAM), and various other forms of volatile or non-volatile storage. Generally speaking, a computer accessible storage medium includes any storage media accessible by a computer during use to provide instructions and/or data to the computer. For example, a computer accessible storage medium includes storage media such as magnetic or optical media, e.g., disk (fixed or removable), tape, CD-ROM, or DVD-ROM, CD-R, CD-RW, DVD-R, DVD-RW, or Blu-Ray. Storage media further includes volatile or non-volatile memory media such as RAM (e.g. synchronous dynamic RAM (SDRAM), double data rate (DDR, DDR2, DDR3, etc.) SDRAM, low-power DDR (LPDDR2, etc.) SDRAM, Rambus DRAM (RDRAM), static RAM (SRAM), etc.), ROM, Flash memory, non-volatile memory (e.g. Flash memory) accessible via a peripheral interface such as the Universal Serial Bus (USB) interface, etc. Storage media includes microelectromechanical systems (MEMS), as well as storage media accessible via a communication medium such as a network and/or a wireless link.

Additionally, in various implementations, program instructions include behavioral-level descriptions or register-transfer level (RTL) descriptions of the hardware functionality in a high level programming language such as C, or a design language (HDL) such as Verilog, VHDL, or database format such as GDS II stream format (GDSII). In some cases the description is read by a synthesis tool, which synthesizes the description to produce a netlist including a list of gates from a synthesis library. The netlist includes a set of gates, which also represent the functionality of the hardware including the system. The netlist is then placed and routed to produce a data set describing geometric shapes to be applied to masks. The masks are then used in various semiconductor fabrication steps to produce a semiconductor circuit or circuits corresponding to the system. Alternatively, the instructions on the computer accessible storage medium are the netlist (with or without the synthesis library) or the data set, as desired. Additionally, the instructions are utilized for purposes of emulation by a hardware based type emulator from such vendors as Cadence®, EVE®, and Mentor Graphics®.

Although the implementations above have been described in considerable detail, numerous variations and modifications will become apparent to those skilled in the art once the above disclosure is fully appreciated. It is intended that the following claims be interpreted to embrace all such variations and modifications.

What is claimed is:

1. A processor comprising:
circuitry configured to:
execute a guest virtual machine (VM) that utilizes a first hardware topology;
generate a request for latency information between pairs of endpoint devices based on a second hardware topology different from the first hardware topology; and
in response to receiving a response comprising the latency information, schedule tasks on endpoint devices of the first hardware topology based on the latency information.

2. The processor as recited in claim 1, wherein the circuitry is further configured to schedule a task for transferring data between a given pair of endpoints of the first hardware topology, responsive to determining a given latency of the latency information corresponding to the given pair of endpoints is less than any latency of the latency information corresponding to each other pair of endpoints of the first hardware topology.

3. The processor as recited in claim 1, wherein the second hardware topology comprises at least one pair of endpoint devices of the first hardware topology being physically incapable of transferring data with one another in the second hardware topology.

4. The processor as recited in claim 3, wherein:
the first hardware topology is a virtual hardware topology used by the guest VM; and
the second hardware topology is a physical hardware topology used by a computing system that supports the guest VM.

5. The processor as recited in claim 1, wherein:
the first hardware topology comprises a single root complex; and
the second hardware topology comprises a plurality of root complexes.

6. The processor as recited in claim 1, wherein the response is received from a topology manager comprising a security processor.

7. The processor as recited in claim 6, wherein the circuitry is further configured to:
collect, via the security processor, physical identifiers of components of the second hardware topology from a host processor of the second hardware topology not used in the guest VM;
determine, using the physical identifiers, the latency information based on physical placement of the components within the second hardware topology; and
create a table storing the latency information.

8. A method comprising:
executing, by circuitry of a processor, a guest VM that utilizes a first hardware topology;
generating, by the circuitry, a request for latency information between pairs of endpoint devices based on a second hardware topology different from the first hardware topology;
sending, by the circuitry, the request to a topology manager; and
in response to receiving a response from the topology manager comprising the latency information, scheduling, by the circuitry, tasks on endpoint devices of the first hardware topology based on the latency information.

9. The method as recited in claim 8, further comprising scheduling, by the circuitry, a task for transferring data between a given pair of endpoints of the first hardware topology, responsive to determining a given latency of the latency information corresponding to the given pair of endpoints is less than any latency of the latency information corresponding to each other pair of endpoints of the first hardware topology.

10. The method as recited in claim 8, wherein the second hardware topology comprises at least one pair of endpoint devices of the first hardware topology being physically incapable of transferring data with one another in the second hardware topology.

11. The method as recited in claim 10, wherein:
the first hardware topology is a virtual hardware topology used by the guest VM; and
the second hardware topology is a physical hardware topology used by a computing system that supports the guest VM.

12. The method as recited in claim 8, wherein:
the first hardware topology comprises a single root complex; and
the second hardware topology comprises a plurality of root complexes.

13. The method as recited in claim 8, wherein the topology manager comprises at least a security processor.

14. The method as recited in claim 13, further comprising:
collecting, via the security processor, physical identifiers of components of the second hardware topology from a host processor of the second hardware topology not used in the guest VM;
determining, by the security processor using the physical identifiers, the latency information based on physical placement of the components within the second hardware topology; and
creating, by the security processor, a table storing the latency information.

15. A computing system comprising:
a memory configured to store instructions of one or more tasks and source data to be processed by the one or more tasks;
a plurality of endpoint devices; and
a processor of a given endpoint device configured to:
execute the instructions using the source data;
execute a guest virtual machine (VM) that utilizes a first hardware topology;
generate a request for latency information between pairs of endpoint devices of the plurality of endpoint devices based on a second hardware topology different from the first hardware topology;
send the request to a topology manager; and
in response to receiving a response from the topology manager comprising the latency information, schedule tasks on the plurality of endpoint devices based on the latency information.

16. The computing system as recited in claim 15, wherein the processor is further configured to schedule a task for transferring data between a given pair of endpoints of the first hardware topology, responsive to determining a given latency of the latency information corresponding to the given pair of endpoints is less than any latency of the latency information corresponding to each other pair of endpoints of the first hardware topology.

17. The computing system as recited in claim 15, wherein the second hardware topology comprises at least one pair of endpoint devices of the first hardware topology being physically incapable of transferring data with one another in the second hardware topology.

18. The computing system as recited in claim 17, wherein:
the first hardware topology is a virtual hardware topology used by the guest VM; and
the second hardware topology is a physical hardware topology used by a computing system that supports the guest VM.

19. The computing system as recited in claim 15, wherein the topology manager comprises at least a security processor.

20. The computing system as recited in claim 19, wherein the processor is further configured to:
collect, via the security processor, physical identifiers of components of the second hardware topology from a host processor of the second hardware topology not used in the guest VM;
determine, using the physical identifiers, the latency information based on physical placement of the components within the second hardware topology; and
create a table storing the latency information.
